(19) United States
(12) Patent Application Publication
(10) Pub. No.: US 2005/0160041 A1
(43) Pub. Date: Jul. 21, 2005

(54) Smartcard-based root certificate methods and apparatuses

(75) Inventors: Daniel C. Griffin, Seattle, WA (US); Philip J. Hallin, Port Townsend, WA (US); Eric C. Perlin, Redmond, WA (US); Klaus U. Schutz, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/761,489

(22) Filed: Jan. 20, 2004

(51) Int. Cl. G06F 17/60

(52) U.S. Cl. 705/50

(57) ABSTRACT

Methods and apparatuses are provided for use with smartcards or other like shared computing resources. One or more root certificates are stored on a smartcard. The root certificates can be selectively copied to a certificate store or other like mechanism of an operatively coupled computing or like device and available to support certificate and other trust related processes of the device. When the smartcard is no longer operatively available to the device, the root certificates are no longer available to support such certificate and other trust related processes of the device.

### TECHNICAL FIELD

The present invention relates generally to computers and like devices, and more particularly to improved methods and apparatuses that provide root certificates or other types of trust information on smartcards and other like sharable computing resources.

### BACKGROUND

Computing networks and environments vary in size and purpose. Most computer networks and computing systems require potential users to present some sort of proof that they are allowed to access the computing resources. Typically, users are required to enter a qualifying user name and password prior to accessing the system. Some network security schemes require potential users to present a portable token or other like mechanism to help verify that they are authorized to access certain resources. For example, smartcards are becoming more popular for authenticating users. Additionally, there is usually a need to establish trusted relationships between various computing devices and resources to further control and manages the computing environment.

At the core of this trust are security policies which are implemented through the use of various tools and techniques. For example, cryptography, and certification techniques built thereon, is commonly implemented to provide certain security services that allow entities to trust each other.

Cryptography techniques may be categorized as either symmetric cryptography or asymmetric cryptography. With symmetric cryptography, the same secret key is used for both encryption and decryption. This means that the symmetric key needs to be shared between the encrypting party and the decrypting party. Any party having a copy of the symmetric key may therefore decrypt and read a message. Hence, there is a need to protect and maintain control over the symmetric key. Security is provided through the protection of the key being used by the sender and the receiver. As long as only the sender and receiver know the secret symmetric key value, the message is protected (assuming a robust encryption algorithm is used).

Asymmetric cryptography (public key cryptography) is typically based on a “key pair”. Here, one key in the pair is referred to as the “public” key. As the name implies, a public key may be shared with others and even published in a public directory, for example. The other key is referred to as the “private” key. Also consistent with its name, the private key is meant to be kept secret and secure by the party. Although the two keys are mathematically related, the private key cannot be determined from the public key.

Encryption and signing are two typical operations associated with public key cryptography. Data that is encrypted using a public key can only be decrypted using the associated private key and vice versa. Signing allows one to verify the source of a piece of data. Signing does not, however, protect the data from being viewed by anyone who has access to the sender's public key. In asymmetric cryptography, security is provided through the protection of the private keys.

Asymmetric cryptography is also often employed to provide authentication, non-repudiation and data integrity security mechanisms. Authentication provides assurance that a message was actually sent by the party indicated. Non-repudiation provides assurance that a sender cannot later deny having sent certain data. Data Integrity provides assurance that a message was not modified prior to reaching its destination.

These security mechanisms are typically provided by using a hash function in conjunction with public key cryptography. A hash function is basically an encoding scheme that is quick to compute and results in a relatively short numeric representation of the message that was hashed. Hash functions have several uses, including, for example, authentication, nonrepudiation and data integrity. Thus, a hash function is a one-way function, which means that one cannot retrieve the message from the resulting hash value. The slightest change to the original message will result in a clearly detectable change of the hash value. Similarly, it would likely be computationally infeasible to find two different messages that result in the same hash value. Additionally, a good hash is typically a compression function for which the output is always a fixed size.

Some processes use a hash function in conjunction with public key cryptography to provide a security service often referred to as “signing”. For example, in certain systems, when a user signs a message, a hash of the message is calculated and then encrypted using the sender's private key. The resulting encrypted hash is referred to as the “digital signature”. The original plaintext message, the digital signature, and the sender's certificate which contains the sender's public signing key are then sent to the recipient. Once received, the digital signature is decrypted using the sender's public key that was sent along with the message in the form of a certificate. The receiving client also generates a hash value for the plaintext message using the same hash function as did the sender. The resulting hash value can then be compared with the received hash value to detect differences. If the two hash values match, then the message must have originated from the sender who posses the private key. Hence, this provides authentication and non-repudiation. Furthermore, since the message was not changed during transit, data integrity is provided.

The underlying trust of key-pair is typically established using a certificate. In certain systems, a certificate is a user's public key that has been digitally signed by a trusted authority, typically referred to as Certification Authority (CA). When a certificate is received, the digital signature can be examined to insure that a trusted entity issued it. This validation usually occurs for each intermediate CA's certificate until a trusted issuing root certificate is reached. Certificates and the foundational root certificates are maintained in a secure and trusted manner on conventional computing devices. For example, typical computer operating systems establish and maintain a certificate store that provides the trust policies for the computing device and/or user(s). The hierarchical association of multiple certificates is commonly referred to as certificate chaining.

A Public Key Infrastructure (PKI), for example as illustrated above, uses public key cryptography to create an environment where parties are able to communicate and share information in a secure manner based on established trust. This trust is established using one or more certificates chained to a root certificate (e.g., an organization's top-level certificate) in which trust is inherently assumed. To be considered valid, all certificate chains must terminate in a trusted root certificate.

Typically root certificates are distributed in various ways. For example, tools are available that allow an administrator or other like super-user to manually add root certificated to the system of a local computing device. In another example, a domain administrator may use other tools that allow for the distribution of root certificate(s) to groups of computing devices, for example, within a network/forest using the public key group policy. If an external CA only needs to be trusted by a small number of computing devices, for example within an enterprise, then a group policy may be implemented that applies the desired settings to only those computing devices requiring the trust.

In a typical PKI, several layers of CAs will exist. A CA has two primary functions: issue certificates to subordinate CAs or end-entities (such as users and computers) and the revocation of those issued certificates when they become invalid. The CA may accomplish revocation by placing the invalid certificate(s) on a certificate revocation list (CRL) and making the list available to all entities that are configured to trust the validity of the revoked certificate.

The certificate chain validation process usually involves retrieving and analyzing all intermediate certificates (subordinate CA certificates) in a certificate chain. It is possible that the client is missing all or part of the certificate chain used to validate a certificate. Authority Information Access (AIA) locations, published in certificates by the CA, are used to tell the verifier of a certificate where to retrieve a CA's certificate. An AIA typically uses LDAP, HTTP, or FILE uniform resource identifiers (URIs) to point to locations where the intermediate certificates reside. By verifying the validity of all intermediate CAs and the root CA in a certificate chain, trust in the certificate can be established.

Establishing the requisite PKI trust is not without its problems, however. There are situations in which setting up the certificates can be difficult. For example, bootstrapping PKI trust can be difficult as currently available mechanisms have limitations. Take for instance domain policy in the case of enterprise users. Here, policy can usually only be applied after a computing device has fully joined the domain. Strong authentication of the domain controller during the domain joining process is not possible since the enterprise certificate chain is not yet available during the joining phase.

Furthermore, conventional enterprise-oriented root certificate distribution mechanisms do not typically work for users that seek to access enterprise resources from non-enterprise locations, e.g., working from home. Here, for example, home users may not able to fully and securely authenticate the enterprise servers, since the server's certificate may chain to a root certificate not present on the home user's workstation.

Additional potential problems may affect roaming users since they may not be able to easily choose the entities to trust and always have that information available in a portable manner. This plays an important role in e-commerce. For example, when a user goes to a shared machine, or kiosk, to conduct a secure transaction, the user cannot always be assured that the transaction is with an entity he/she has explicitly chosen to trust.

Existing solutions for portable storage of user data tend to not be secure. For example, no current mechanism exists for ensuring the integrity of data stored on a floppy or USB device. That type of storage device is therefore ill suited to transport root certificates.

Consequently, there is a need for methods and apparatuses for distributing, transporting and/or otherwise maintaining root certificates and other like certificate information.

### SUMMARY

Methods and apparatuses are provided for distributing, transporting and/or otherwise maintaining root certificates and other like certificate information.

The above stated needs and others are met, for example, by a method that includes determining if a smartcard having smartcard memory is operatively available, identifying at least one root certificate stored in the smartcard memory, and reading the root certificate from the smartcard memory. The root certificate may then be stored in a device operatively coupled to the smartcard. For example, the root certificate may be added to a certificate store maintained in a computer's memory. In certain implementations, the method also includes authenticating information associated with the smartcard prior to identifying or otherwise accessing the root certificate in the smartcard memory.

The method may also include determining when the smartcard is no longer operatively available and no longer storing the root certificate in the device when the smartcard is no longer operatively available. For example, the root certificate stored in a certificate store in the computer's memory may be removed or erased.

The above needs and others are also satisfied by a system that includes a computing device having computer memory and a smartcard interface device that is operatively coupled to the computing device and configurable to operatively interface to a smartcard that has smartcard memory with at least one root certificate stored therein. The computing device includes logic that is configured to identify when the smartcard is operatively available via the smartcard interface device, identify the root certificate in the smartcard memory, and cause the smartcard interface device to read the identified root certificate from the smartcard memory and provide the root certificate to the logic. The logic can be further configured to store the root certificate in a certificate store maintained in the computer memory. The logic may also be configured to determine when the smartcard is no longer operatively available, and remove the root certificate in the certificate store when the smartcard is no longer operatively available. The logic may also be configured to determine when the user is no longer logged in to the workstation, and remove the root certificate in the certificate store when the user is no longer logged in.

Another exemplary method includes determining if a smartcard is operatively available and storing at least one root certificate in the smartcard's memory. This method may include authenticating information associated with the smartcard prior to storing the root certificate in the smartcard's memory.

Still another exemplary method includes determining if a smartcard having smartcard memory with at least one root certificate stored therein is operatively available, and removing the root certificate from the smartcard memory. Here, the method may also include authenticating information associated with the smartcard prior to removing the at least one root certificate from the smartcard memory.

In accordance with yet other aspects, a smartcard is provided which has memory in which at least one root certificate is stored.

### BRIEF DESCRIPTION OF THE DRAWINGS

A more complete understanding of the various methods and apparatuses of the present invention may be had by reference to the following detailed description when taken in conjunction with the accompanying drawings wherein:

FIG. 1 is a block diagram that depicts a contemporary computer system that can be used with a smartcard or other like portable mechanism.

FIG. 2 is a block diagram depicting an example of a system configured to support a smartcard root certificates.

FIG. 3 is a flow diagram depicting certain exemplary acts associated with a method for copying a root certificate from a smartcard to a certificate store.

FIG. 4 is a flow diagram depicting certain exemplary acts associated with a method for removing a root certificate from a certificate store.

FIG. 5 is a flow diagram depicting certain exemplary acts associated with a method for copying a root certificate to a smartcard.

FIG. 6 is a flow diagram depicting certain exemplary acts associated with a method for removing a root certificate from a smartcard.

### DETAILED DESCRIPTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

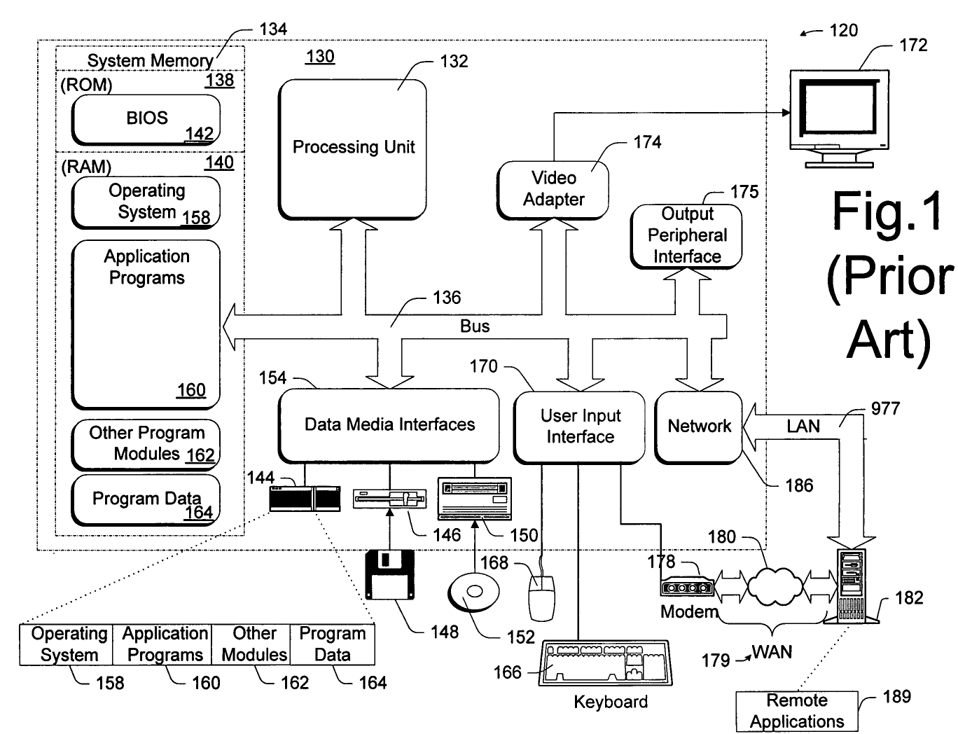

FIG. 1 illustrates an example of a suitable computing environment 120 with which the subsequently described methods and apparatuses may be implemented.

Exemplary computing environment 120 is only one example of a suitable computing environment and is not intended to suggest any limitation as to the scope of use or functionality of the improved methods and apparatuses described herein. Neither should computing environment 120 be interpreted as having any dependency or requirement relating to any one or combination of components illustrated in computing environment 120.

The improved methods and apparatuses herein are operational with numerous other general purpose or special purpose computing system environments or configurations. Examples of well known computing systems, environments, and/or configurations that may be suitable include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As shown in FIG. 1, computing environment 120 includes a general-purpose computing device in the form of a computer 130. The components of computer 130 may include one or more processors or processing units 132, a system memory 134, and a bus 136 that couples various system components including system memory 134 to processor 132.

Bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computer 130 typically includes a variety of computer readable media. Such media may be any available media that is accessible by computer 130, and it includes both volatile and non-volatile media, removable and non-removable media.

In FIG. 1, system memory 134 includes computer readable media in the form of volatile memory, such as random access memory (RAM) 140, and/or non-volatile memory, such as read only memory (ROM) 138. A basic input/output system (BIOS) 142, containing the basic routines that help to transfer information between elements within computer 130, such as during start-up, is stored in ROM 138. RAM 140 typically contains data and/or program modules that are immediately accessible to and/or presently being operated on by processor 132.

Computer 130 may further include other removable/non-removable, volatile/non-volatile computer storage media. For example, FIG. 1 illustrates a hard disk drive 144 for reading from and writing to a non-removable, non-volatile magnetic media (not shown and typically called a “hard drive”), a magnetic disk drive 146 for reading from and writing to a removable, non-volatile magnetic disk 148 (e.g., a “floppy disk”), and an optical disk drive 150 for reading from or writing to a removable, non-volatile optical disk 152 such as a CD-ROM, CD-R, CD-RW, DVD-ROM, DVD-RAM or other optical media. Hard disk drive 144, magnetic disk drive 146 and optical disk drive 150 are each connected to bus 136 by one or more interfaces 154.

The drives and associated computer-readable media provide nonvolatile storage of computer readable instructions, data structures, program modules, and other data for computer 130. Although the exemplary environment described herein employs a hard disk, a removable magnetic disk 148 and a removable optical disk 152, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 148, optical disk 152, ROM 138, or RAM 140, including, e.g., an operating system 158, one or more application programs 160, other program modules 162, and program data 164.

The improved methods and apparatuses described herein may be implemented within operating system 158, one or more application programs 160, other program modules 162, and/or program data 164.

A user may provide commands and information into computer 130 through input devices such as keyboard 166 and pointing device 168 (such as a “mouse”). Other input devices (not shown) may include a microphone, joystick, game pad, satellite dish, serial port, scanner, camera, etc. These and other input devices are connected to the processing unit 132 through a user input interface 170 that is coupled to bus 136, but may be connected by other interface and bus structures, such as a parallel port, game port, or a universal serial bus (USB).

A monitor 172 or other type of display device is also connected to bus 136 via an interface, such as a video adapter 174. In addition to monitor 172, personal computers typically include other peripheral output devices (not shown), such as speakers and printers, which may be connected through output peripheral interface 175.

Computer 130 may operate in a networked environment using logical connections to one or more remote computers, such as a remote computer 182. Remote computer 182 may include many or all of the elements and features described herein relative to computer 130.

Logical connections shown in FIG. 1 are a local area network (LAN) 177 and a general wide area network (WAN) 179. Such networking environments are commonplace in offices, enterprise-wide computer networks, intranets, and the Internet.

When used in a LAN networking environment, computer 130 is connected to LAN 177 via network interface or adapter 186. When used in a WAN networking environment, the computer typically includes a modem 178 or other means for establishing communications over WAN 179. Modem 178, which may be internal or external, may be connected to system bus 136 via the user input interface 170 or other appropriate mechanism.

Depicted in FIG. 1, is a specific implementation of a WAN via the Internet. Here, computer 130 employs modem 178 to establish communications with at least one remote computer 182 via the Internet 180.

In a networked environment, program modules depicted relative to computer 130, or portions thereof, may be stored in a remote memory storage device. Thus, e.g., as depicted in FIG. 1, remote application programs 189 may reside on a memory device of remote computer 182. It will be appreciated that the network connections shown and described are exemplary and other means of establishing a communications link between the computers may be used.

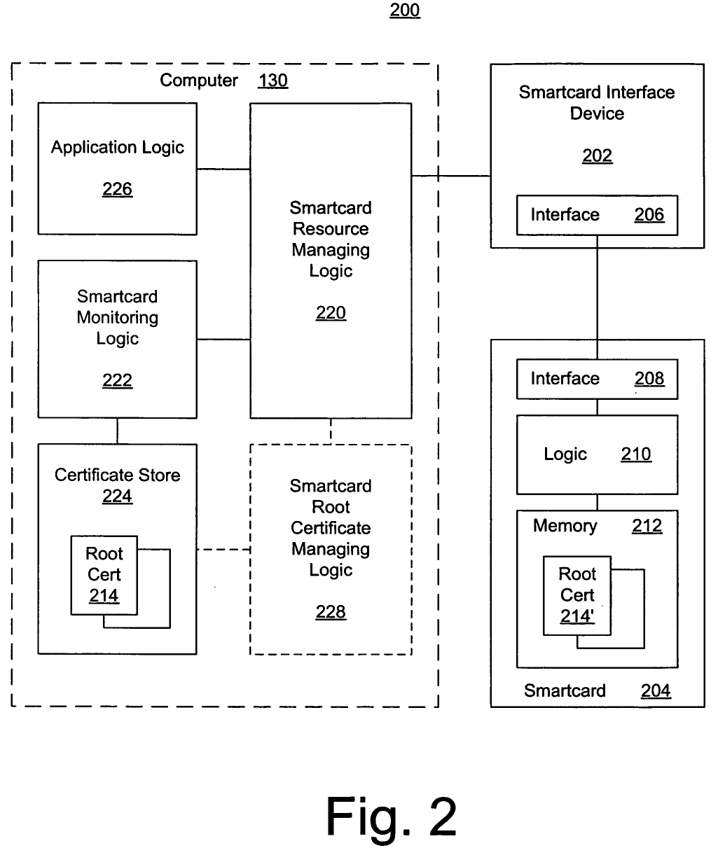

Attention is now drawn to FIG. 2, which is a block diagram depicting an example of a system 200 configured to support a smartcard 204 having at least one root certificate 214′.

System 200 includes computer 130, a smartcard interface device 202 and a smartcard 204. Smartcard interface device 202 is operatively coupled to computer 130 (e.g., through data media interface 154 in FIG. 1) and to smartcard 204 through interface 206 in smartcard interface device 202 and corresponding interface 208 in smartcard 204. Interfaces 206 and 208 are, for example, physically/electrically connecting electrodes and/or other interface supporting circuitry configured to support requisite communications. In other exemplary implementations, interfaces 206 and 208 are electromagnetically coupled and configured support the requisite communications when these interface are brought into sufficient proximity to one another.

As shown in this example, smartcard 204 also includes logic 210 and memory 212. Here, for example, logic 210 is configured to perform applicable processes and functions provided by smartcard 204. In performing such processes and functions, logic 210 is configured to access memory 212 as needed. In accordance with the exemplary methods and apparatuses described herein, memory 212 includes static or otherwise persistent memory storing at least one root certificate 214′. Those skilled in the art will recognize that logic 210 and/or memory 212 can be configured in a variety of ways to promote the secure storage of root certificate 214′. In certain implementations, for example, to add/remove or otherwise edit root certificate information maintained on smartcard 204 requires further authentication by the user/account. For example, to add or remove root certificate information a user of computer 130 or smartcard interface device 202 may be required to enter a password or other code that can be authenticated by logic 210. Such authentication may also be required to gain access to root certificate information and/or even to discover the presence of root certificate information within memory 212.

Root certificate 214′ may take a variety of forms based on the certification methodology being supported. In certain implementations, for example, root certificate information is provided to support the directory methodology defined by ITU-T Recommendation X.509.

Computer 130 in FIG. 2 is illustratively depicted as having smartcard resource managing logic 220, smartcard monitoring logic 222, certificate store 224, application logic 226, and (optionally) smartcard root certificate managing logic 228.

It is noted that the term “logic” as used herein is representative of any combination of hardware, firmware, and/or software logic components. Indeed, in certain implementations, such logic may also include analog or other like circuitry, memory circuitry/devices, communication circuitry, etc. as needed to perform the functions/processes accordingly.

Smartcard resource managing logic 220 is operatively coupled to smartcard interface device 202, which provides further connectivity to smartcard 204. Smartcard resource managing logic 220 is configured to control and/or otherwise promote access to smartcard 204. Hence, for example, if application logic 226 needs to access smartcard 204, application logic 226 will use smartcard resource managing logic 220. Similarly, if smartcard monitoring logic 222 or smartcard root certificate managing logic 228 needs to access smartcard 204, each will use smartcard resource managing logic 220.

Smartcard monitoring logic 222 is operatively coupled to certificate store 224, which may be maintained, for example, in system memory 134, e.g., RAM 140 and/or within a data storage mechanism such as a hard drive. Root certificates, certificate chains, certificate stores and other like arrangements within computers are common and well known. In this example, certificate store 224 includes at least one root certificate 214.

Smartcard monitoring logic 222 is configured to determine if/when smartcard 204 is operatively available (i.e., present and accessible through smartcard resource managing logic 220 and smartcard interface device 202). Here, smartcard 204 is considered available. Smartcard monitoring logic 222 is also configured to determine if smartcard 204 includes root certificate 214′. If root certificate 214′ is on smartcard 204, then smartcard monitoring logic 222 is configured to copy root certificate 214′ from smartcard 204 to certificate store 224 as root certificate 214.

Smartcard monitoring logic 222 is also configured to determine if/when smartcard 204 is no longer operatively available (i.e., no longer present and/or accessible through smartcard resource managing logic 220 and smartcard interface device 202). Assuming that smartcard 204 is no longer operatively available, smartcard monitoring logic 222 then identifies that root certificate 214 in certificate store 224 was previously copied from smartcard 204 and since smartcard 204 is no longer operatively available smartcard monitoring logic 222 removes root certificate 214 from certificate store 224.

Assuming that root certificate 214 is in certificate store 224 and smartcard 204 is still operatively available, application logic 226 or any other applicable logic in computer 130 can then access or otherwise use root certificate 214 as needed to perform certificate supported processes. In certain implementations, application logic 226 may be operatively configured to access certificate store 224 more directly, e.g., without using smartcard resource managing logic 220.

In certain implementations, computer 130 may also include smartcard root certificate managing logic 228, which is configured to copy or otherwise provide root certificate 214′ to smartcard 204. For example, in FIG. 2, smartcard root certificate managing logic 228 can be configured to copy root certificate 214 from certificate store 224 or some other source to smartcard 204 through smartcard resource managing logic 220 and smartcard interface device 202. In this manner, an administrator or other duly authorized user can establish one or more root certificates on smartcard 204. Similarly, smartcard root certificate managing logic 228 can be configured to allow for the removal of a root certificate 214′ from smartcard 204. In certain implementations, to add or remove root certificate from smartcard 204, a user/account authentication process must be satisfied accordingly.

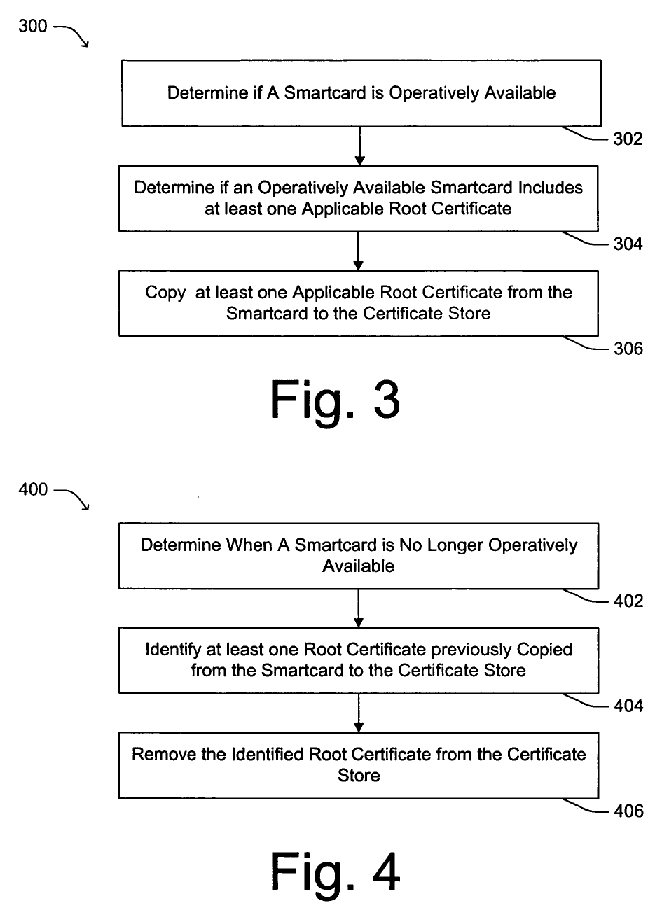

Attention is now drawn to FIG. 3, which is a flow diagram depicting certain exemplary acts associated with a method 300 for copying root certificate 214′ from smartcard 204 to certificate store 224.

In act 302, it is determined if a smartcard is operatively available. In act 304 it is determined if an operatively available smartcard includes at least one applicable root certificate. Act 304 may include, therefore, first authenticating that a user/account is able to use root certificate 214′. In act 306, one or more applicable root certificates and/or related information is copied to certificate store 224 of computer 130.

FIG. 4 is a flow diagram depicting certain exemplary acts associated with a method 400 for removing root certificate 214 from certificate store 224.

In act 402, it is determined when a smartcard is no longer operatively available. In act 404 it is determined if one or more root certificates and/or related information were previously copied to certificate store 224 (e.g., as per act 302). In act 406, any identified root certificates and/or related information is removed or otherwise erased from certificate store 224 of computer 130.

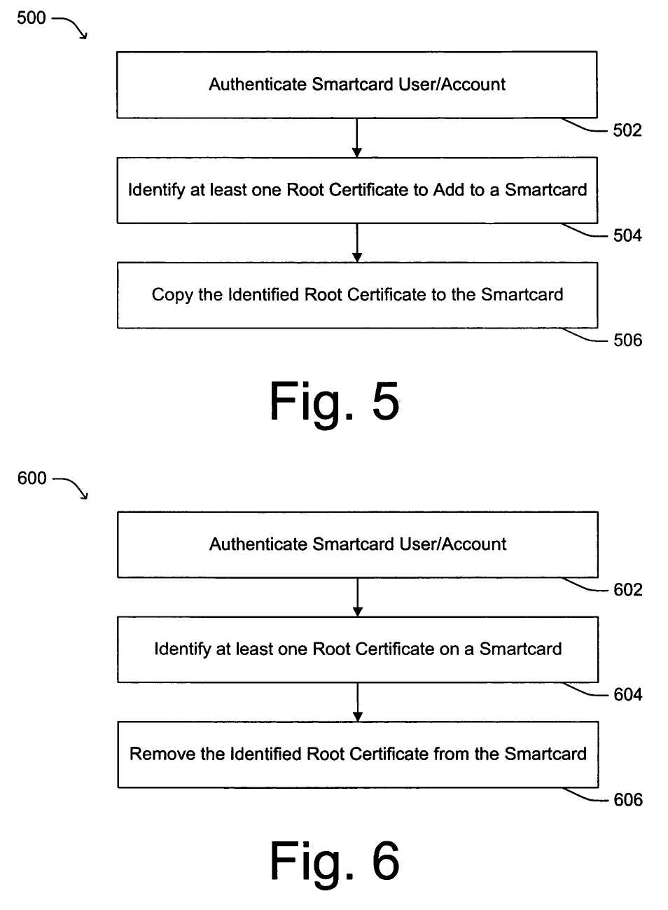

FIG. 5 is a flow diagram depicting certain exemplary acts associated with a method 500 for copying root certificate 214′ to smartcard 204.

In act 502, user/account information associated with smartcard 204 is authenticated. In act 504, following authentication in act 502 at least one root certificate is identified and in act 506 copied or otherwise added to smartcard 204 as root certificate 214′.

FIG. 6 is a flow diagram depicting certain exemplary acts associated with a method 600 for removing root certificate 214′ from smartcard 204.

In act 602, user/account information associated with smartcard 204 is authenticated. In act 604, following authentication in act 602 at least one root certificate 214′ is identified on smartcard 204 and in act 606 removed or otherwise erased from smartcard 204.

Although some preferred implementations of the various methods and apparatuses have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

1. A method comprising:
determining if a smartcard is operatively available, said smartcard having smartcard memory;
identifying at least one root certificate stored in said smartcard memory; and
reading said at least one root certificate from said smartcard memory.

2. The method as recited in claim 1, further comprising:
storing said at least one root certificate in a device operatively coupled to said smartcard.

3. The method as recited in claim 2, wherein said device includes a computing device having computer memory, and wherein storing said at least one root certificate in said device operatively coupled to said smartcard further includes:
adding said at least one root certificate to a certificate store maintained in said computer memory.

4. The method as recited in claim 1, wherein identifying said at least one root certificate stored in said smartcard memory further includes authenticating information associated with said smartcard prior to identifying said at least one root certificate.

5. The method as recited in claim 2, further comprising:
determining when said smartcard is no longer operatively available; and
no longer storing said root certificate in said device when said smartcard is no longer operatively available.

6. The method as recited in claim 2, further comprising:
determining when an account associated with said smartcard is not active; and
no longer storing said root certificate in said device when said account is not active.

7. The method as recited in claim 6, wherein said account is associated with a user and determining when said account is not active includes determining is said user is currently logged on.

8. The method as recited in claim 5, wherein no longer storing said root certificate in said device when said smartcard is no longer operatively available includes:
removing said stored root certificate from a certificate store maintained in computer memory of said device.

9. A computer readable medium having computer-implementable instructions for causing one or more processing units to perform acts comprising:
determining if a smartcard, having smartcard memory with at least one root certificate stored therein, is operatively available; and
reading said at least one root certificate from said smartcard memory.

10. The computer readable medium as recited in claim 9, having further computer-implementable instructions for causing one or more processing units to perform acts comprising:
storing said at least one root certificate in a device operatively coupled to said smartcard.

11. The computer readable medium as recited in claim 10, having further computer-implementable instructions for causing one or more processing units to perform acts comprising:
adding said read root certificate to a certificate store maintained in computer memory of said device.

12. The computer readable medium as recited in claim 9, having further computer-implementable instructions for causing one or more processing units to perform acts comprising:
authenticating information associated with said smartcard prior to reading said at least one root certificate.

13. The computer readable medium as recited in claim 10, further comprising:
determining when said smartcard is no longer operatively available; and
no longer storing said root certificate in said device when said smartcard is no longer operatively available.

14. The computer readable medium as recited claim 10, further comprising:
determining when an account associated with said smartcard is not active; and
no longer storing said root certificate in said device when said account is not active.

15. The method as recited in claim 14, wherein said account is associated with a user and determining when said account is not active includes determining is said user is currently logged on.

16. The computer readable medium as recited in claim 13, wherein no longer storing said root certificate in said device when said smartcard is no longer operatively available includes:
removing said stored root certificate from a certificate store maintained in computer memory of said device.

17. A system comprising:
a computing device having computer memory;
a smartcard interface device operatively coupled to said computing device and configurable to operatively interface to a smartcard, having smartcard memory with at least one root certificate stored therein; and
wherein said computing device includes logic configured to identify when said smartcard is operatively available via said smartcard interface device, identify said root certificate in said smartcard memory, and cause said smartcard interface device to read said identified root certificate from said smartcard memory and provide said root certificate to said logic.

18. The system as recited in claim 17, wherein said logic is further configured to store said root certificate in a certificate store maintained in said computer memory.

19. The system as recited in claim 17, wherein said logic is further configured to authenticate information associated with said smartcard prior to causing said smartcard interface device to read said root certificate.

20. The computer readable medium as recited in claim 18, wherein said logic is further configured to determine when said smartcard is no longer operatively available, and remove said root certificate in said certificate store when said smartcard is no longer operatively available.

21. A method comprising:
determining if a smartcard is operatively available, said smartcard having smartcard memory; and
storing at least one root certificate in said smartcard memory.

22. The method as recited in claim 21, further comprising:
authenticating information associated with said smartcard prior to storing said at least one root certificate in said smartcard memory.

23. A computer readable medium having computer-implementable instructions for causing one or more processing units to perform acts comprising:
identifying when a smartcard is operatively available, said smartcard having smartcard memory; and
storing at least one root certificate in said smartcard memory.

24. The computer readable medium as recited in claim 23, having further computer-implementable instructions for causing one or more processing units to perform acts comprising:
authenticating information associated with said smartcard prior to storing said at least one root certificate in said smartcard memory.

25. An apparatus comprising logic configured to identify when a smartcard is operatively available, said smartcard having smartcard memory, and store at least one root certificate in said smartcard memory.

26. The apparatus as recited in claim 25, wherein said logic is further configured to authenticate information associated with said smartcard prior to storing said at least one root certificate in said smartcard memory.

27. A method comprising:
determining if a smartcard is operatively available, said smartcard having smartcard memory with at least one root certificate stored therein; and
removing said at least one root certificate from said smartcard memory.

28. The method as recited in claim 27, further comprising:
authenticating information associated with said smartcard prior to removing said at least one root certificate from said smartcard memory.

29. A computer readable medium having computer-implementable instructions for causing one or more processing units to perform acts comprising:
identifying if a smartcard is operatively available, said smartcard having smartcard memory with at least one root certificate stored therein; and
removing said at least one root certificate from said smartcard memory.

30. The computer readable medium as recited in claim 29, having further computer-implementable instructions for causing one or more processing units to perform acts comprising:
authenticating information associated with said smartcard prior to removing said at least one root certificate from said smartcard memory.

31. An apparatus comprising logic configured to identify when a smartcard is operatively available, said smartcard having smartcard memory with at least one root certificate stored therein, and remove said at least one root certificate from said smartcard memory.

32. The apparatus as recited in claim 31, wherein said logic is further configured to authenticate information associated with said smartcard prior to removing said at least one root certificate from said smartcard memory.

33. A smartcard having memory in which at least one root certificate is stored.
